(19) United States
(12) Patent Application Publication
(10) Pub. No.: US 2026/0031992 A1
(43) Pub. Date: Jan. 29, 2026

(54) PLATFORM FOR TOKENIZING DIGITAL IDENTITIES AND DISTRIBUTING CONTENT

(71) Applicants: Max NUKI, Newport, RI (US); John Nicholas ANDERSON, Barre, VT (US)

(72) Inventors: Max NUKI, Newport, RI (US); John Nicholas ANDERSON, Barre, VT (US)

(21) Appl. No.: 19/280,835

(22) Filed: Jul. 25, 2025

Related U.S. Application Data
(60) Provisional application No. 63/675,388, filed on Jul. 25, 2024.
(60) Provisional application No. 63/812,475, filed on May 27, 2025.

(51) Int. Cl. H04L 9/32; H04L 9/00

(52) U.S. Cl. CPC H04L 9/3213; H04L 9/50

(57) ABSTRACT

Systems and methods that present verified digital content to users are described. For example, a digital platform may generate an identity token for a source/user of a piece of digital content, verify the piece of digital content based on the identity token, and cause the piece of digital content to be displayed in a feed of content based on the verification (e.g., displaying a section of verified content and a second of unverified content). The digital platform may distinguish authentic content from unverified (and potentially fake) content, among other benefits.

### CROSS REFERENCE TO RELATED APPLICATIONS

This application claims priority to U.S. Provisional Patent Application No. 63/675,388, filed on Jul. 25, 2024, entitled PLATFORM FOR TOKENIZING DIGITAL IDENTITIES AND DISTRIBUTED CONTENT, and U.S. Provisional Patent Application No. 63/812,475, filed on May 27, 2025, entitled PLATFORM FOR TOKENIZING DIGITAL IDENTITIES AND DISTRIBUTED CONTENT, which are hereby incorporated by reference in their entirety.

### BACKGROUND

In the digital world, the proliferation of fake news by bad actors is ubiquitous and undercuts the great benefits otherwise enabled by a connected environment. The rise of artificial intelligence (AI) and machine learning (ML) only accelerates such issues, giving these bad actors powerful tools to generate content that is misleading, erroneous, and often harmful to individuals and society as a whole.

Typically, discerning between real and fake content relied on qualitative assessments of the content—the source of the content, the quality of the content, the reach of the content, and so on. However, as content generation (e.g., via AL/ML) increases in sophistication, such assessments become less reliable in identifying what is fake and what is real.

The systems and methods described herein provide technical solutions to address such issues.

### BRIEF DESCRIPTION OF THE DRAWINGS

Embodiments of the present technology will be described and explained through the use of the accompanying drawings.

FIG. 1 is a diagram illustrating a suitable network environment for presenting verified content to users.

FIG. 2 is a diagram illustrating example modules of a verification platform.

FIG. 3 is a diagram illustrating an example method for displaying content in an online environment.

FIG. 4 is a diagram illustrating an example method for generating a digital identity for a user.

FIG. 5 is a diagram illustrating an example method for verifying a piece of digital content.

FIG. 6 is a diagram illustrating an example user interface for a content feed having verified and unverified digital content.

FIG. 7 is a diagram illustrating an example user interface for a decentralized content feed having verified and unverified digital content.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various systems and methods for tokenizing digital identities and/or distributing content are described. A digital platform, which may support or be part of a news aggregation site and/or social media platform, provides technology that mitigates issues that arise from a world of fake content, facilitating a digital environment of authentic, enhanced, and trusted online experiences.

In some examples, the digital platform may access pieces of digital content, determine, for each piece of digital content of the multiple pieces of digital content, whether the piece of digital content is verified, allocate or provide each piece of digital content to a portion of an online environment based on the determination, and display the feed of multiple pieces of digital content within the online environment based on the allocation.

For example, the digital platform may generate an identity token for a source/user of a piece of digital content, verify the piece of digital content based on the identity token, and cause the piece of digital content to be displayed in a feed of content based on the verification. The feed may include a section of verified content and a second of unverified content. Thus, in various examples, the digital platform, by applying or implementing the technical solutions described herein, can provide users with a digital environment that sorts or otherwise distinguishes authentic content from unverified (and potentially fake) content, among other benefits.

Various embodiments of the system, methods, and/or platform will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific examples or embodiments.

### Examples of a Suitable Online Environment

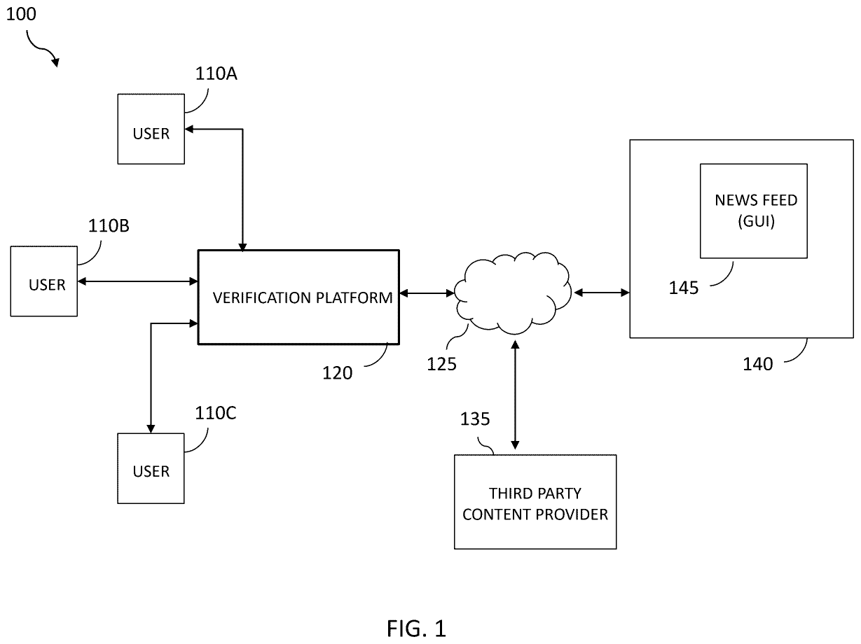

FIG. 1 is a diagram illustrating a suitable network environment 100 for presenting verified content to users. A verification platform 120 (e.g., a digital platform that supports one or more processing modules or components) communicates with multiple different users 110A-C, such as users that provide digital content (e.g., news articles, video, podcasts, images, and so on) for online consumption.

An online environment 140, such as a webpage, website, social media feed, mobile application, smart TV, and so on, may be supported and/or associated with the verification platform 120. The online environment 140, which may be part of a remote server that communicates with the verification platform 120 over a network 125, supports or provides a news feed or other feed of digital content via a graphical user interface (GUI) 145 that is configured to present or display the digital content to users within or associated with the online environment 140. As depicted, the digital content may be verified content provided by the verification platform 120, unverified content provided by various third party content providers 135 (e.g., unauthenticated press releases), and so on.

For example, the news feed may be part of a social media application that dynamically updates a decentralized social media feed or otherwise aggregates digital content (e.g., a newswire) to be displayed to its members. The verification platform 120, based on authenticating and/or verifying the users 110A-C and/or digital content provided by the users 110A-C, enables the online environment 140 to identify whether digital content is authenticated/verified or unauthenticated/unverified. Thus, using the modules and techniques of the verification platform 120, the online environment 140 may render, display, or otherwise present digital content (e.g., via the GUI 145) along with indicators of the authenticity of the content, within an overall feed of content (e.g., which may be a mix of authenticated and unauthenticated content). Further details are described herein.

The platform, components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, magnetic or optical cards, flash memory, or other types of media/machine-readable medium suitable for storing electronic instructions.

The network 125, or cloud, can be any network, ranging from a wired or wireless local area network (LAN), to a wired or wireless wide area network (WAN), to the Internet or some other public or private network, to a cellular system or network (e.g., 4G, LTE, 5G, or 6G network), and so on. Further, the user device can be any computing device and/or mobile device, including a smart phone, tablet, laptop, desktop computer, gaming device, and so on. While the connections between the various devices and the network 120 and are shown as separate connections, these connections can be any kind of local, wide area, wired, or wireless network, public or private.

Further, any or all components depicted in the Figures described herein can be supported and/or implemented via one or more computing systems, services (e.g. cloud instances), or servers. Although not required, aspects of the various components or systems are described in the general context of computer-executable instructions, such as routines executed by a general-purpose computer, e.g., mobile device, a server computer, a cloud computer or service, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, cloud-based systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Personal Area Network (PAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of the Verification Platform

As described herein, the verification platform 120 facilitates a technical authentication of digital content, enabling an online environment (e.g., the online environment 140) to provide a feed of content that indicates different levels of authenticity for the digital content within the feed. Thus, users of the online environment 140 can consider the authenticity of the digital content (e.g., the source/author and/or the content itself) when viewing, watching, or otherwise interacting with the feed and/or its presented content.

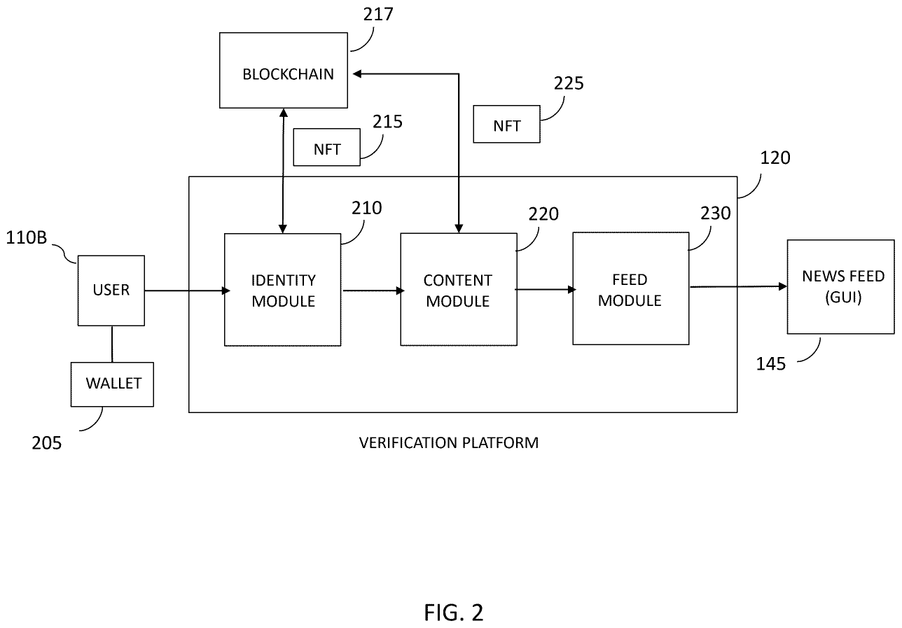

FIG. 2 is a diagram illustrating example modules of the verification platform 120. As used herein, in some examples, a component or module of the verification platform 120 is a processor-implemented module/component and represents a computing device having a processor that is at least temporarily configured and/or programmed by executable instructions stored in memory to perform one or more of the particular functions that are described herein.

The verification platform 120 receives information from multiple users, such as the user 110B. An identity module 210 is configured and/or programmed to generate, create, or modify a digital identity for the user 110B. The digital identity, which may be stored or contained in a digital wallet 205 associated with the user 110B (e.g., stored by the verification platform 120 and/or the user 110B), is based on a non-fungible token (NFT), such as an identity token 215 that is minted to a blockchain 217. The digital wallet 205 may include a secure/encrypted storage area and/or may store multiple addresses for the user 110B.

In some cases, the verification platform 120 maintains a user score (e.g., a MeedScore) for the user 110B, which acts as a metric or signifier for the user 110B, such as a score that represents the authenticity of the user 110B, the activities performed by the user 110B (e.g., interactions with content or advertising, acting as a content provider), the rewards obtained by the user 110B, the prestige associated with the user 110B (e.g., via feedback received from other users), and so on.

In some examples, the identity module 210 may mint or otherwise generate the identity tokens 215 for any user that interacts with digital content (e.g., not only users that provide digital content). For example, the identity module 210 may mint the identity token 215 for a user that joins the online environment 140 or a specific news feed or social media platform.

Actions performed by the user (e.g., consuming or interacting with content, viewing advertising, providing content, providing feedback for other users (e.g., confirming a verification of a user) or participating in crowdsourced information collection, and so on) may contribute to the user score for the user and be represented/authenticated by an associated identity token. Thus, the user score may be a combination of scoring actions (e.g., completing a task or performing an activity), earning a badge or achievement, winning a reward, and so on.

A content module 220 enables the user 110B (and other users) to publish digital content (e.g., feed items (e.g., press releases), multimedia content, and so on). The content module 220 authenticates the content by minting the content as a content token 225 that is minted to the blockchain 217. Thus, via the content module 220, the verification platform 120 provides users with a mechanism for authenticating text, images, videos, advertising, and other digital content for submission or aggregation to one or more feeds of content (e.g., the news feed presented by the GUI 145).

A feed module 230 distributes the authenticated content (e.g., the tokenized content) to the online environment 140 (e.g., various web2 and web3 channels or sites). For example, the feed module 230 may provide or include one or more application programming interfaces (APIs), which may enable newswires or other content publishing services (e.g., the online environment 140) to receive or access digital content from the verification platform 120.

In some cases, the verification platform 120 supports multiple layers of encryption applied to the digital content. For example, the use of a RESTful architecture (e.g., via the feed module 230) to authenticate the users 110A-C and provided content ensures a secure capture or access to the digital content and other communications. The verification platform 120, therefore, utilizes the APIs to implement a protocol that designates approved (e.g., authenticated) affiliates, such as community members (e.g., enterprises and influencers) empowered to employ customized onboarding, registration, authentication, and so on.

As described herein, the identity token 215 for a user (e.g., the user 110B) may enable community members to verify the identities of other members with zero knowledge about the others users. The identity token 215 may act or perform as a central hub to provide public information about you, your business, and so on. The associated digital wallet 205 may include multiple digital wallet addresses (e.g., five), such as Ethereum compatible addresses.

The digital wallet 205 may be secure in a variety of ways, such as via a 24-keyword mnemonic phrase and/or a private key, and may store various crypto assets, such, as fungible tokens, NFTs, smart contracts, and so on. The digital wallet 205 may be compatible with different protocols (e.g., such as ERC20, ERC1155, ERC721). Further, the digital wallet 205 may include safe blockchain storage (e.g., employing multi-signature technology and sodium-envelope storage), such as a quantum-level protected storage area that contains the identity token 215 for the user and/or other digital assets.

The API may be customizable, modular, and/or supports on-chain and off-chain integrations with the users 110A-C. In some cases, the API may include aspects to facilitate the capture of information for identity registration and authentication (e.g., biometrics, locations, document signatures, disclosures, and so on), common registration protocols or procedures, zero-knowledge authentication and management, communication with blockchains (e.g., the blockchain 217, such as a blockchain supporting an Ethereum-compatible Layer-2 blockchain protocol), the online environment 140, other web2 channels (e.g., social media feeds or platforms), and so on.

As described herein, the verification platform 120 mints and/or employs content tokens 225 when authenticating and/or tokenizing content for distribution to the online environment 140. For example, the verification platform 120 may generate a digital content package (e.g., a multimedia press release package), which may include all of the assets/content associated with a press release and its metadata (e.g., endorsed by the user or other users). The content module 220 may mint the content token 225 to the blockchain 217 (e.g., a Polygon blockchain), such as by using the ERC721 token standard (or a new, specific standard) to act as a pointer to the press release data and/or facilitate the buying/selling of the content via existing marketplaces.

Further, the verification platform 120 may interact with and/or employ aspects of a pre-boarding platform, which may prequalify users and/or provide initial assessments of users (via determined or current digital personas) during their authentication. Further details regarding the pre-boarding platform may be found in U.S. patent application Ser. No. 17/502,719, filed on Oct. 15, 2021, entitled ONLINE PLATFORM FOR CONNECTING USERS TO GOODS AND SERVICES, which is hereby incorporated by reference in its entirety.

Thus, as described herein, the verification platform 120 provides an automated and secure service of providing a newswire with content (e.g., digital content, such as authenticated press releases), such that the newswire (or other online environment 140) can disambiguate authenticated/verified content from unauthenticated/unverified/fake content (e.g., fake news).

In some examples, the verification platform 120 tokens the distribution of the digital content (e.g., via the feed module 230). For example, the feed module 230 may transfer multiple copies of the same digital content to different users via the ERC1155 token framework (or other Ethereum-compatible blockchains or protocols).

In some examples, the verification platform 120 may utilize AI/ML frameworks or systems (e.g., generative AI) to enhance its operations. For example, the platform 120 may utilize AI/ML when authenticating users, content, and/or content feeds, when generating content, during fact checking, when sorting or otherwise creating feeds of content, when personalizing content for users, when translating content, when policing or moderating content or user activities, and so on.

Thus, the technology described herein may integrate software, blockchain interactions (smart contracts), and UI components, such as by providing a mechanism that connects NFT-authenticated news to a smart contract-driven aggregation platform, a news reader (or other) interface that allows comparative verification of content (verification vs unverified) using NFT metadata and scoring (e.g., dynamically or uniquely rendered based on verification of source content and/or reader/user interactions and/or characteristics), a view-based participation scoring system built into a news reader that traces back to the NFT-authored press release.

For example, the technology may integrate NFT minting, smart contract mechanisms, press release publishing, and a reader interface (e.g., the GUI 145), which may be tied into a scoring system that outputs scores, rankings, recommendations, unique display layouts, and so on. The UI, for example, may support the visual tracking and comparison of content authenticity (within the UI), such as via the funnel and advertiser UI elements, among other benefits.

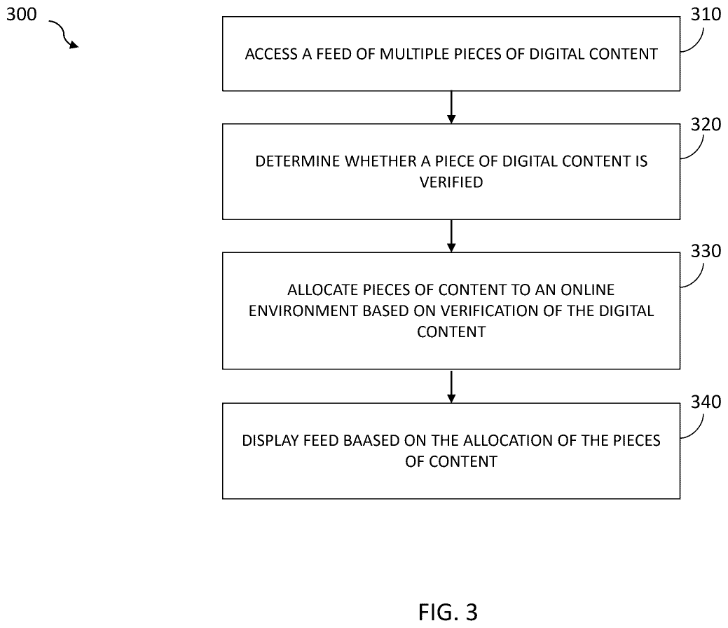

FIG. 3 is a diagram illustrating an example method 300 for displaying content in an online environment. The method 300 may be performed by the verification platform 120 and, accordingly, is described herein merely by way of reference thereto. It will be appreciated that the method 300 may be performed on any suitable hardware.

In operation 310, the verification platform 120 accesses a feed of multiple pieces of digital content. For example, the content module 220 may receive or otherwise access a piece of digital content (e.g., a press release and associated metadata) from the user 110B.

In operation 320, the verification platform 120 determines, for each piece of digital content of the multiple pieces of digital content, whether the piece of digital content is verified. For example, the content module 220 may determine, based on an identity token for a user associated with each piece of digital content, whether the content is associated with a verified user (e.g., a verified digital identity within the platform 120) or an unverified user. Thus, the content module 220 may verify and/or authenticate a piece of digital content based on determining a source of the piece of digital content being verified.

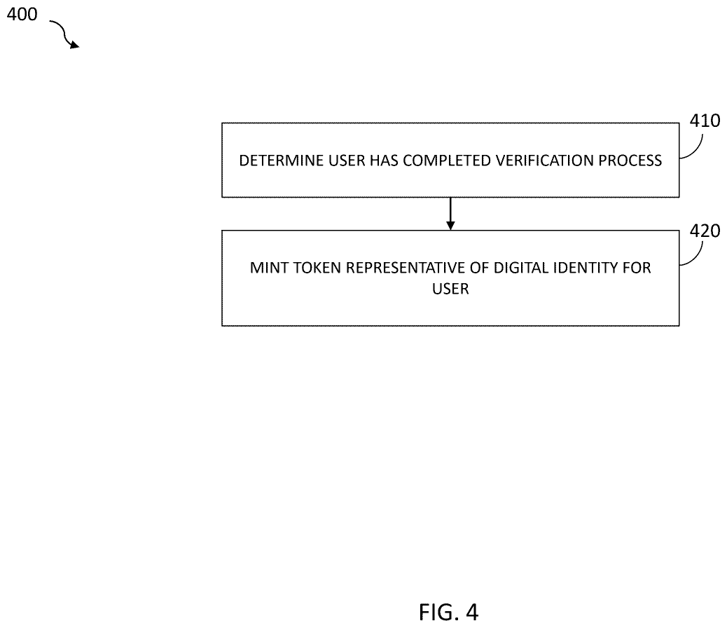

As described herein, the verification platform 120 may generate a digital identity for a user or source. FIG. 4 depicts an example method 400 for generating a digital identity for a user. The method 400 may be performed by the verification platform 120 and, accordingly, is described herein merely by way of reference thereto. It will be appreciated that the method 400 may be performed on any suitable hardware.

In operation 410, the verification platform 120 determines a user has completed a verification process, and, in operation 420, mints a token representative of a digital identity for the user. For example, once the user (e.g., the source) has provided registration information (as described herein), the platform 120 mints a token (e.g., the identity token 215) to represent the user (e.g., to represent an authenticated user).

In some examples, the verification platform 120 may utilize different mechanism or levels of authentication when determining whether the piece of digital content is verified. For example, the verification platform 120 may:
Determine the piece of digital content is verified when an identity token associated with a source/user of the piece of digital content is verified or authenticated;
Determine the piece of digital content is verified when an identity token (e.g., the identity token 215) associated with a source/user of the piece of digital content is verified and/or authenticated and when a content token (e.g., the content token 225) associated with the piece of digital content (e.g., or content that includes the piece of digital content) is verified and/or authenticated;
Determine the piece of digital content is verified when a user score associated with the source/user is above or satisfies a threshold score for verification and/or authentication (e.g., for all content and/or for different types of content). For example, a press release may be associated with one threshold score (e.g., a comparatively lower score), whereas a video may be associated with a different threshold score (e.g., a comparatively higher score);
Determine the piece of digital content is verified when the source/user is associated with feedback from other users (e.g., crowdsourced input) that indicates the source/user is a legitimate source for digital content and/or for a specific type or field of digital content; and so on.

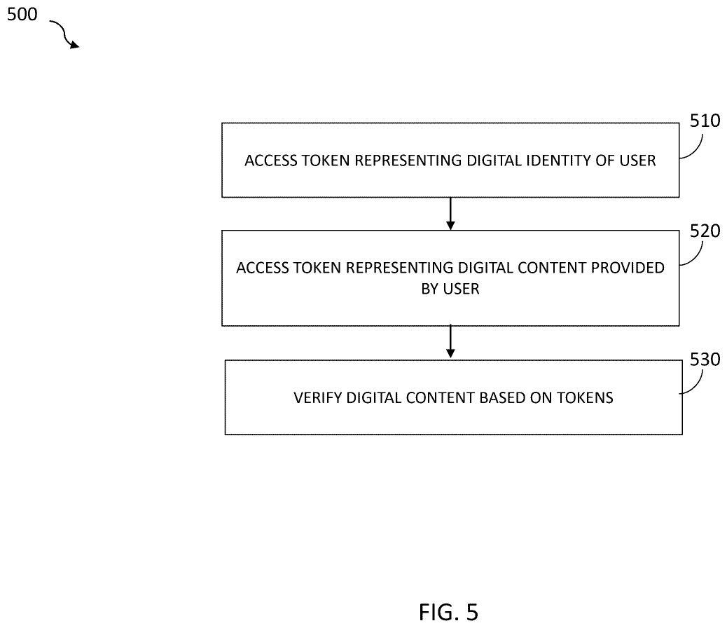

For example, FIG. 5 depicts an example method 500 for verifying a piece of digital content. The method 500 may be performed by the verification platform 120 and, accordingly, is described herein merely by way of reference thereto. It will be appreciated that the method 500 may be performed on any suitable hardware.

In operation 510, the verification platform 120 accesses an identity token representing a digital identity of a source/user and, in operation 520, accesses a content token representing digital content provided by the source/user. In operation 530, the verification platform 120 verifies the digital content based on both tokens (e.g., the identity token 215 and the content token 225).

Referring back to FIG. 3, in operation 330, the verification platform 120 allocates each piece of digital content to a portion of an online environment based on the determination. For example, the feed module 230 may assign, tag, or otherwise allocate a piece of digital content to a “verified” display column of the news feed (e.g., via the GUI 145) when the piece of digital content is determined to be authentic and/or the source/user is verified/authenticated.

In operation 340, the verification platform 120 displays the feed of multiple pieces of digital content within the online environment based on the allocation. For example, the feed module 330 causes the GUI 145 to display different columns, portions, or sections of content, such as portions that display/present verified content, portions that display/present unverified content (e.g., from the third party content provider 135), and other information (e.g., advertising, navigation elements, and so on).

As described herein, the verification platform 120 may facilitate, generate, and/or present a reader-facing interface (e.g., “Scroller”), which displays content, such as verified content and unverified content. The reader-facing interface may enable scrolling through authenticated news and unverified news, distinguishing between verified content and unverified news from other news agencies/wire services.

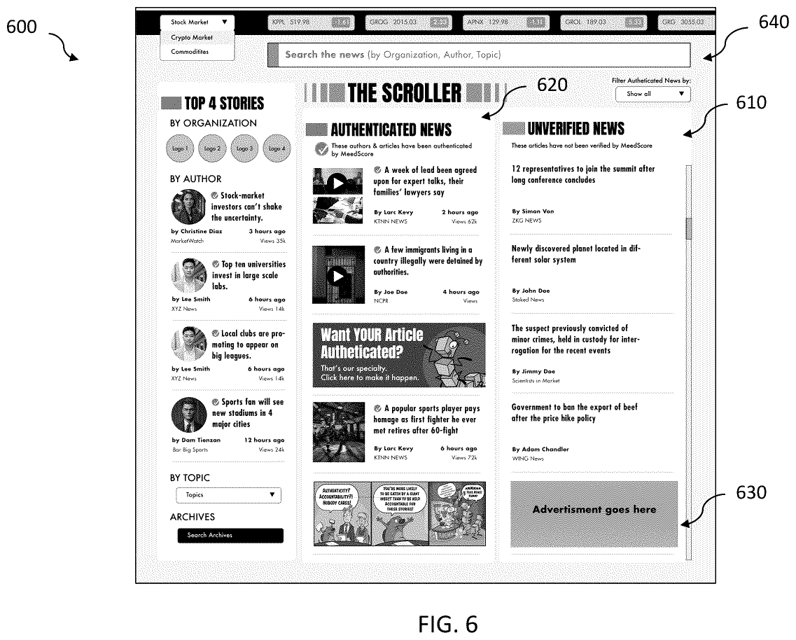

FIG. 6 depicts an example user interface 600 for a content feed having verified and unverified digital content. The UI 600 (e.g., Scroller) presents a “verified news” display 610, an “unverified news” display 620, advertisements 630, and other GUI elements 640. The “verified news” display 610 or section, as described herein, includes feed items that have been verified by the verification platform 120, distinguishing such content from unverified content (e.g., displayed via the “unverified news” section).

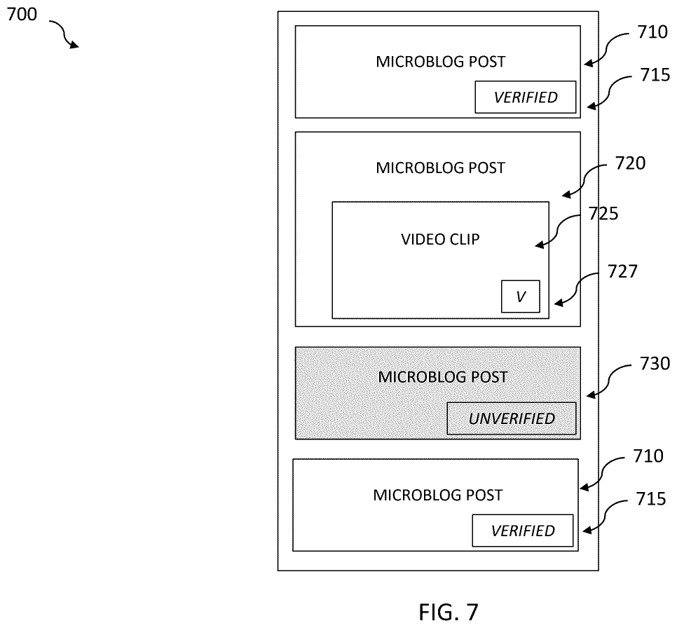

Of course, other online environments may employ the verification platform 120 described herein when displaying digital content to users. FIG. 7 depicts an example user interface 700 for a decentralized content feed having verified and unverified digital content. As shown, the UI 700 includes verified posts 710, along with indicators 715 that the posts are verified by the verification platform 120, an unverified post 730 (with an “unverified” indicator), and a post 720 that includes a verified piece of content 725 (e.g., a video) attached to the post itself (e.g., which may or may not be verified).

The UI 700, which may be a social media platform, can therefore utilize the verification platform 120 to distinguish between verified and unverified posts, verified and unverified sources (e.g., users or authors), verified and unverified content (e.g., video clips, GIFs, reels, images, and so on) within posts, and so on.

### Examples of the Claimed Technology

The technology described herein may be implemented as follows.

In some examples, a non-transitory, computer-readable medium, system, and/or method may include accessing a feed of multiple pieces of digital content, determining, for each piece of digital content of the multiple pieces of digital content, whether the piece of digital content is verified, allocating each piece of digital content to a portion of an online environment based on the determination, and displaying the feed of multiple pieces of digital content within the online environment based on the allocation.

In some cases, determining whether the piece of digital content is verified includes determining a source of the piece of digital content is associated with an identity token minted to a blockchain.

In some cases, determining whether the piece of digital content is verified includes determining a source of the piece of digital content is associated with an identity token minted to a blockchain and determining the piece of piece of digital content is associated with a content token minted to the blockchain.

In some cases, determining whether the piece of digital content is verified includes determining a user score assigned to a user associated with the piece of digital content is above a threshold verification score.

In some cases, the threshold verification score is based on a content type of the piece of digital content.

In some cases, determining whether the piece of digital content is verified includes determining a user score assigned to a user associated with the piece of digital content and based on feedback from other users of the online environment is above a threshold verification score.

In some cases, allocating each piece of digital content to a portion of an online environment based on the determination includes allocating verified pieces of content to a first portion of the online environment and allocating unverified pieces of content to a second portion of the online environment that is different than the first portion.

In some cases, displaying the feed of multiple pieces of digital content within the online environment includes displaying a column of verified pieces of content next to a column of unverified digital content.

In some cases, the online environment is a news aggregation site.

In some cases, the online environment is a social media platform.

In some examples, a non-transitory, computer-readable medium, system, and/or method may include generating an identity token for a source of a piece of digital content, verifying the piece of digital content based on the identity token, and causing the piece of digital content to be displayed in a feed of content based on the verification.

In some cases, causing the piece of digital content to be displayed in a feed of content based on the verification includes presenting a section of verified content that includes the piece of digital content that is separated from other content displayed in the feed of content.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A non-transitory, computer-readable medium whose contents, when executed by a computing system, cause the computing system to perform a method, the method comprising:
accessing a feed of multiple pieces of digital content;
determining, for each piece of digital content of the multiple pieces of digital content, whether the piece of digital content is verified;
allocating each piece of digital content to a portion of an online environment based on the determination; and
displaying the feed of multiple pieces of digital content within the online environment based on the allocation.

2. The computer-readable medium of claim 1, wherein determining whether the piece of digital content is verified includes determining a source of the piece of digital content is associated with an identity token minted to a blockchain.

3. The computer-readable medium of claim 1, wherein determining whether the piece of digital content is verified includes:
determining a source of the piece of digital content is associated with an identity token minted to a blockchain; and
determining the piece of piece of digital content is associated with a content token minted to the blockchain.

4. The computer-readable medium of claim 1, wherein determining whether the piece of digital content is verified includes determining a user score assigned to a user associated with the piece of digital content is above a threshold verification score.

5. The computer-readable medium of claim 1, wherein the threshold verification score is based on a content type of the piece of digital content.

6. The computer-readable medium of claim 1, wherein determining whether the piece of digital content is verified includes determining a user score assigned to a user associated with the piece of digital content and based on feedback from other users of the online environment is above a threshold verification score.

7. The computer-readable medium of claim 1, wherein allocating each piece of digital content to a portion of an online environment based on the determination includes:
allocating verified pieces of content to a first portion of the online environment; and
allocating unverified pieces of content to a second portion of the online environment that is different than the first portion.

8. The computer-readable medium of claim 1, wherein displaying the feed of multiple pieces of digital content within the online environment includes displaying a column of verified pieces of content next to a column of unverified digital content.

9. The computer-readable medium of claim 1, wherein the online environment is a news aggregation site.

10. The computer-readable medium of claim 1, wherein the online environment is a social media platform.

11. A system that renders content for an online environment, the system comprising:
a processor coupled with memory, wherein the processor is configured to:
access multiple pieces of digital content;
determine, for each piece of digital content of the multiple pieces of digital content, whether the piece of digital content is verified;
allocate each piece of digital content to a portion of the online environment based on the determination; and
display the multiple pieces of digital content within the online environment.

12. The system of claim 11, wherein determining whether the piece of digital content is verified includes determining a source of the piece of digital content is associated with an identity token minted to a blockchain.

13. The system of claim 11, wherein determining whether the piece of digital content is verified includes:
determining a source of the piece of digital content is associated with an identity token minted to a blockchain and
determining the piece of piece of digital content is associated with a content token minted to the blockchain.

14. The system of claim 11, wherein determining whether the piece of digital content is verified includes determining a user score assigned to a user associated with the piece of digital content is above a threshold verification score.

15. The system of claim 11, wherein the threshold verification score is based on a content type of the piece of digital content.

16. The system of claim 11, wherein determining whether the piece of digital content is verified includes determining a user score assigned to a user associated with the piece of digital content and based on feedback from other users of the online environment is above a threshold verification score.

17. The system of claim 11, wherein allocating each piece of digital content to a portion of an online environment based on the determination includes:
allocating verified pieces of content to a first portion of the online environment; and
allocating unverified pieces of content to a second portion of the online environment that is different than the first portion.

18. The system of claim 11, wherein displaying the feed of multiple pieces of digital content within the online environment includes displaying a column of verified pieces of content next to a column of unverified digital content.

19. A method, comprising:
generating an identity token for a source of a piece of digital content;
verifying the piece of digital content based on the identity token; and
causing the piece of digital content to be displayed in a feed of content based on the verification.

20. The method of claim 19, wherein causing the piece of digital content to be displayed in a feed of content based on the verification includes presenting a section of verified content that includes the piece of digital content that is separated from other content displayed in the feed of content.
